(19) United States
(12) Patent Application Publication
(10) Pub. No.: US 2014/0329975 A1
(43) Pub. Date: Nov. 6, 2014

(54) INTERPENETRATING DILATANT POLYMER NETWORK FOR IMPACT PROTECTION

(71) Applicants: Eamonn Swanton, Luton (GB); Georgij Smelin, Luton (GB)

(72) Inventors: Eamonn Swanton, Luton (GB); Georgij Smelin, Luton (GB)

(73) Assignee: HEALES ENTERPRISES LIMITED, Luton, Bedfordshire (GB)

(21) Appl. No.: 14/110,513

(22) PCT Filed: Apr. 10, 2012
(86) PCT No.: PCT/GB12/50786

§ 371 Date: Feb. 18, 2014

(30) Foreign Application Priority Data
Apr. 8, 2011 (GB) 1106016.7

(51) Int. Cl. C08G 77/42; C08G 71/04

(52) U.S. Cl. CPC C08G 77/42; C08G 71/04; C08G 2270/00
USPC 525/453

(57) ABSTRACT

An interpenetrating or semi interpenetrating polymer network comprises first and second network polymers, wherein at least the first network polymer comprises a rheopectic and/or a dilatant material.

The present invention relates to polymer materials especially polymers capable of resisting impacts or other applied forces.

Impact protection materials for use in protective equipment have often employed elastomeric materials, for example in the form of elastomers or foams, to provide resilient materials which allow for the absorption of impact forces across a relatively large area.

Such elastomeric materials may also be used in a composite with a more rigid material which may assist in the spreading of the impact force across a relatively large area. However, such rigid materials, when used in the field of personal protective equipment, may impede the free movement of the wearer.

Rheopectic materials are forms of non-Newtonian fluids which undergo an increasing viscosity the longer those materials are exposed to a shearing force. Similarly, dilatant materials are also non-Newtonian fluids which exhibit a time independent increase in viscosity when exposed to shear forces.

As is understood by those skilled in the art, rheopectic and dilatant materials absorb energy from shear forces as their viscosities increase, redissipating that energy once the shear force reduces or ceases.

Designers of protective equipment have sought to include rheopectic or dilatant materials in their products at least in part because of these properties of energy absorption and of remaining flexible or fluid when not exposed to shear forces. These materials also tend to be lighter than the usual alternatives which is a further advantage.

Such attempts include the provision of dilatant or rheopectic materials in laminates of more conventional protective materials, for example KEVLAR®.

The inventors have devised a practical alternative to the use of such laminates.

In a first aspect, the invention provides an interpenetrating polymer network or a semi interpenetrating polymer network comprising first and second network polymers, wherein at least the first polymer comprises a rheopectic and/or a dilatant material.

The terms “rheopectic” and dilatant”, as used to herein, refer to a material which exhibits a tensile strength of XMPa when extended to 2% deformation at 1 Hz, and a tensile strength of at least X+3MPa when extended to 2% deformation at 10 Hz.

Preferably, the first polymer comprises a polyalkyl siloxane, e.g. a polydialkyl siloxane such as polydimethyl siloxane.

Preferably the first polymer comprises a crosslinking portion which preferably comprises a borate group.

In some embodiments the polydialkyl siloxane comprises siloxane repeat units are substituted with straight C₁ to C₁₀ (e.g. C₅) alkyl chains.

Preferably, at least some of the siloxane repeat units comprise a first alkyl substituent and a second alkyl substituent. Preferably, the first alkyl substituent is a methyl substituent. Preferably, the second alkyl substituent comprises a C₃ to C₁₀ straight alkyl chain, e.g. a pentyl substituent.

In some embodiments some or all of the siloxane repeat units comprise different alkyl substituents to one or both of their neighbouring siloxane repeat units.

Preferably, a mean of at least 4 siloxane groups which do not comprise the second alkyl substituent separate siloxane groups which comprise the second alkyl substituent. More preferably, a mean of between 5 and 30 (e.g. 10 to 20) siloxane groups which do not comprise the second alkyl substituent separate siloxane groups which comprise the second alkyl substituent.

Preferably, the polydialkyl siloxane polymer comprises a block of first siloxane repeat units having substantially the same alkyl substituents.

Preferably, the polydialkyl siloxane comprises a block of second siloxane repeat units having substantially the same alkyl substituents and where at least one of said alkyl substituents in different to at least one of the alkyl substituents of the first siloxane repeat unit.

Preferably, the second network polymer comprises urethane links.

Preferably, the second network polymer comprises polyether links.

Preferably, the second network polymer is not bonded, e.g. covalently bonded, to the first polymer network, but is inseparable therefrom.

Preferably, the second network polymer is bonded, e.g. covalently bonded to the first polymer network.

Preferably, the second network polymer is bonded to the first polymer network by the second alkyl substituent.

Preferably, the second polymer is bonded to the first polymer by urethane links, e.g. urethane-urea links.

A further aspect of the invention provides a network comprising a first network polymer comprising a polyalkylsiloxane and a second network polymer comprising a urethane, wherein the first and second network polymers are bonded there being a single such bond to every 500 g to 5000 g of the first network polymer.

Preferably, the first polymer comprises a single bond to the second polymer in every 300 g/mol block to 3000 g/mol block of the second polymer.

Preferably, the first polymer comprises a single bond to the second polymer in every 500 g/mol block to 2000 g/mol block of the second polymer, for example 800 g/mol block to 1800 g/mol block, e.g. 900 g/mol block to 1600 g/mol block of the second polymer.

Preferably, the first polymer comprises bonds to the second polymer positioned on at least some of the alkyl substituents.

In a further aspect, the invention provides protective material, e.g. body armour, comprising an interpenetrating polymer network or semi interpenetrating polymer network as described above.

In a further aspect, the invention provides a method for manufacturing an interpenetrating polymer network or a semi interpenetrating polymer network comprising:
at least partially cross-linking a polydialkyl siloxane;
introducing a second polymer precursor to the at least partially cross-linked polydialkyl siloxane;
at least partially polymerising and/or crosslinking the second polymer precursor.

Preferably the polydialkyl siloxane is cross-linked by reaction with one or more boric acids and/or boronic acids or esters of boric or boronic acids.

Preferably, the polydialkyl siloxane is formed by hydrolysis of one or more alkylhalosilanes, e.g. dialkylhalosilanes, and/or by hydrolysis of alkyl siloxanes, e.g. mono- or dialkyl siloxanes.

Preferably, the one or more alkylhalosilanes are formed by Grignard reactions of haloalkanes with one or more halosilanes or alkylhalosilanes, e.g. monoalkyltrihalosilanes or dialkyldihalosilanes.

In alternative embodiments, the one or more alkyhalosilanes are formed by hydrosilylation.

Preferably, the polyalkyl siloxane comprises alkyl substituents, at least a portion of which comprise first reactive groups, e.g. hydroxyl groups.

In some embodiments, the first reactive groups may be reacted with a second reactive group, e.g. an isocyanate such as diisocyanate or polyisocyanate.

Preferably some or all of the alkyl substituents comprising the first reactive groups comprise straight C₃ to C₁₀ (e.g. C₅) alkyl chains.

Preferably, the second polymer precursor comprises a polyether or polyurethane polymer.

In preferred embodiments, the second polymer precursor comprises a polyether-co-polyurethane polymer.

Preferably, the second polymer precursor comprises at least a first crosslinkable polymer.

Additionally or alternatively, the second polymer precursor comprises one or more monomers.

Preferably, the first crosslinkable polymer comprises a partially crosslinked polymer, e.g. a polyether-co-polyurethane polymer.

Preferably, the partially crosslinked polymer comprises a polyether-co-polyurethane polymer partially crosslinked by glycerol, or glycerol based compound, e.g. castor oil.

Preferably, the second polymer precursor is crosslinked by reaction some or all of the first and/or second (if present) reactive groups of the polydialkyl siloxane polymer.

Preferably, the partially crosslinked polymer terminates in amine and/or isocyanate groups.

Preferably, the polymer precursor comprises a further, preferably linear, polymer species, the further polymer species preferably terminating in amine and/or isocyanate groups.

Preferably, the further polymer species comprises a polyether polymer.

In order that the invention be more fully understood, it will now be described by way of example only.

The present invention relates to composite materials and their manufacture. In certain embodiments, those materials comprise interpenetrating polymer networks (IPNs) having a rheopectic and/or dilatant first polymer network interpenetrated with a rigid/elastic polymer network.

In one preferred embodiment, the invention comprises an IPN of a borane cross-linked polydialkyl siloxane and a polyurethane.

The polydialkyl siloxane was prepared in three stages.

### Stage 1

In a first step, 0.97 g Grignard grade magnesium turnings (0.04 mole), 45 ml diethyl ether (about 0.4 mole), 9.2 g 1,5-Dibromopentane (0.04 mole), 6.0 g trichloromethyl silane (0.04 mole) and 5.2 g dichloromethyl (0.04 mole) silane were consecutively introduced to a dry vessel and stirred at around 200 rpm for 15 minutes at around 15° C., using an ice-bath to reduce and/or control the temperature where required.

The liquid first becomes yellow then quickly turns a cloudy grey.

The frequency of the stirring was then reduced to 70 rpm for a further five minutes.

The temperature of the liquid was maintained at or below 24° C. by use of an ice bath, as required.

The liquid was then stirred at 20° C. for one hour at 120 to 150 rpm.

A white powder of bromomagnesium chloride and some particles of magnesium were visible in the flask.

The temperature was increased to around 27° C. and the mixture was stirred at 500 to 700 rpm for 2 hours until the reaction reached completion.

The temperature of the vessel was reduced until ice-cold.

### Stage 2

In a second stage, 650 ml ice-cold water was introduced to a vessel and stirred in an ice bath at 1000 rpm. The contents of the reaction vessel of the first stage was then slowly introduced to the cold water.

Remaining white salt left in the first stage was washed with diethyl ether which was then also introduced to the cold water.

The stirring was continued for around 3 to 4 minutes before being stopped. The vessel was then left without agitation for around 10 minutes to effect a phase separation.

The organic layer was collected and washed with concentrated sodium chloride until its pH increased to 7, and again separated.

The organic layer was then dried at 70° C. under constant stirring and was further stirred under vacuum at ambient temperature for 15 minutes.

The resultant colourless oil was a mixture of cyclo and linear siloxane oligomers.

FTIR spectra: Si—Me 1260 cm⁻¹—very strong sharp peak; OH 3400 cm⁻¹—strong wide absorption; CH₂—H bond (in Me) 2962 cm⁻¹—strong sharp peak (about 30% of magnitude of the Si—Me peak); 2900 cm⁻¹ and 2860 cm⁻¹ strong sharp absorption peaks of methylene groups of pentanol attached to a siloxane chain (about 50% of magnitude of the Si—Me peak).

### Stage 3

0.5 g boric acid was dissolved in 20 ml distilled water at 70° C. in a covered beaker, to which mixture is added 30 ml tetra hydro furan.

Stirring was continued after the boric acid was dissolved, to which solution was added 2.2 g di-hydroxyl terminated polydimethyl siloxane (average M_{w} 550. The temperature of the mixture was increased to 150° C. and the mixture was stirred for a further 10 minutes.

The siloxane oil produced in Stage 2 was added over the course of 10 minutes under continuous stirring. The temperature of the mixture was raised to 160° C. for around 10 to 15 minutes.

The temperature of the mixture was then further raised to 175° C. for 15 minutes, again under continuous stirring. The cover of the vessel was removed in order to allow excess solvent to evaporate and the, by now, viscous solution was stirred with a spatula around every 5 minutes.

The boiling water and THF created bubbles on the surface of the siloxane mass, first of around 5 mm in the diameter and less than a second in lifetime, later, as the viscosity increased, up to 20 mm in diameter and 5 to 10 seconds in lifetime.

The resultant siloxane putty was cooled to room temperature and washed in water to remove unreacted boric acid and/or pentanol residues. The putty was then dried.

FTIR spectra: Si—Me 1260 cm⁻¹—very strong sharp peak; OH 3400 cm⁻¹—strong wide absorption; CH2—H bond (in Me) 2962 cm⁻¹—strong sharp peak; 2900 cm⁻¹ and 2860 cm⁻¹ strong sharp absorption peaks of methylene groups of the pentanol attached to a siloxane chain; 1400-1600 cm⁻¹ due to a Si—O—B—O— frequencies).

The putty contained oligomeric siloxane chains linked by borate groups, the siloxane chains containing intermittent pentanol groups attached thereby. The siloxane chains contained one reactive carbon hydroxyl group on approximately each 900 g/mol block.

### Stage 4a

7.9 g of the putty produced in Stage 3 was dissolved in 20 ml dry THF in a dry conical flask. 1.39 g technical grade tolylene-2, 4-diisocyanate (80%)/tolylene-2, 6-diisolcyanate (20%) (TDI) was added to the flask.

The flask was covered and the mixture stirred for 10 minutes.

The mixture was then heated to 85° C. for 50 minutes to form an isocyanate ended prepolymer.

The solution was cooled until ice-cold. Additional THF and methyl ethyl ketone was added to reduce the viscosity of the mixture.

### Stage 4b

Simultaneously, 2.7 g caster oil a, 0.22 g polyethylene glycol (M_{w} approx 1500), 1.39 g TDI, 20 ml dry THF and 20 ml dry ethyl methyl ketone were mixed for 10 minutes in a covered dry conical flask. The combine sum of all castor oil reactive groups and polyethylene glycol hydroxyl groups is 0.8 mol by reactive ends as compared to 1 mole of one of isocyanate groups of the TDI.

The mixture was then heated to 85° C. and stirred for 50 minutes to form an isocyanate ended prepolymer.

The solution was cooled until ice-cold. Additional THF and ethylmethyl ketone was added to reduce the viscosity.

While it is to be appreciated that TDI was used in Stages 4a and 4b any compound having an isocyanate functional group (—N═C═O) may be used, such as any diisocyanate or polyisocyanate.

### Stage 5

2 g poly(propylene glycol)-block-poly(ethylene glycol)-block-poly(propylene glycol) bis(2-aminopropyl ether) (PPO/PPE) of average M_{w} 2000 and 0.11 g 1, 6-diaminohexane were dissolved in 100 ml THF and 50 ml ethyl methyl ketone in an ice-cold, dry conical flask.

Both prepolymers from Stages 4a and 4b were added to the mixture and stirring continued at 500 rpm for 5 minutes, with the mixture remaining ice-cold. This provided a molar ratio of 2 isocyanate groups on the prepolymers to 1 primary amine group on the PPO/PPE.

The mixture was then poured into a polytetrafluoroethylene (PTFE) mould of around 20 mm in diameter. The solvent was allowed to evaporate slowly, preventing the formulation of bubbles in the polymer. The polymer was then left in the mould in dry conditions at 25° C. for 24 hours. A cloudy yellow polymeric tablet (circa 18 g) was formed in the mould.

The tablet was further dried for one week in cool, dry conditions, whereupon its weight had reduced to around 16 g.

The tablet was then placed in an oven at 95° C. for 2 hours to complete the polymerisation.

The resulting tablet was a soft poly(boron-siloxane)/polyurethane IPN.

### Test 1

The rheopectic properties of the tablet were tested by cutting the tablet into a strip 12.5 mm long by 5.6 mm wide by 0.1 mm thick. The strip was loaded into a PerkinElmer DMA 8000 mechanical analyser, where it was placed under oscillatory stress at 2% deformation and a variety of frequencies.

The sample exhibited good rheopectic properties: a tensile modulus of 6 MPa at 2% deformation at 1 Hz and below, about 60 MPa at 2% deformation at 25 Hz, 40 MPa at 2% deformation at 37-50 Hz and about 1 GPa at 2% deformation at 75-90 Hz.

### Test 2

The strength of the sample was measured in the mechanical analyser by measuring the tensile force applied at the point of failure. The sample exhibited a tear resistance of ≧0.7 GPa.

As is understood by those skilled in the art, it is possible to form various shaped articles (for example body armour) from the material by, for example, performing Stage 5 of the synthesis in a mould.

What is claimed is:

1. An interpenetrating or semi interpenetrating polymer network comprising first and second network polymers, wherein at least the first network polymer comprises a rheopectic and/or a dilatant material.

2. (canceled)

3. A polymer network according to claim 1, wherein the first network polymer comprises a crosslinking portion comprising a borate group.

4. A polymer network according to claim 1, wherein the first network polymer comprises a polydialkyl siloxane.

5. A polymer network according to claim 4, wherein the polydialkyl siloxane comprises siloxane repeat units that comprise two different alkyl substituents, and wherein the polydialkyl siloxane polymer comprises a block of first siloxane repeat units having substantially the same alkyl substituents.

6-9. (canceled)

10. A polymer network according to claim 1, wherein the second network polymer comprises a urethane polymer, that is covalently bonded to the first nework polymer.

11-12. (canceled)

13. A polymer network according to claim 10, wherein the second network polymer is bonded to the first network polymer by urethane links

14-16. (canceled)

17. A protective material, comprising an interpenetrating polymer network according to claim 1.

18. A method for manufacturing an interpenetrating polymer network comprising:
at least partially cross-linking a polydialkyl siloxane;
introducing a second polymer precursor to the at least partially cross-linked polydialkyl siloxane;
at least partially polymerising and/or crosslinking the second polymer precursor.

19. A method according to claim 18, wherein the polydialkyl siloxane is cross-linked by reaction with one or more boric acids and/or boronic acids or esters of boric and/or boronic acids.

20. A method according to claim 18, wherein the polydialkyl siloxane is formed by hydrolysis of one or more alkylhalosilanes.

21. A method according to claim 20, wherein the one or more alkylhalosilanes are formed by Grignard reactions of haloalkanes with one or more halosilanes or alkylhalosilanes.

22. (canceled)

23. A method according to claim 18, wherein the polyalkyl siloxane comprises alkyl substituents, at least a portion of which comprise first reactive groups, and wherein the method comprises reacting the first reactive groups with a second reactive group.

24-25. (canceled)

26. A method according to claim 18, wherein the second polymer precursor comprises a polyether, polyurethane polymer, or polyether-co-polyurethane polymer.

27. (canceled)

28. A method according to claim 18, wherein the second polymer precursor comprises at least a first crosslinkable polymer, wherein the first crosslinkable polymer comprises a partially crosslinked polymer.

29-30. (canceled)

31. A method according to claim 28, wherein the partially crosslinked polymer comprises a polyether-co-polyurethane polymer partially crosslinked by glycerol, or glycerol based compound.

32. A method according to claim 23, wherein the second polymer precursor is crosslinked by reacting some or all of the first and/or second (if present) reactive groups of the polydialkyl siloxane polymer.

33. A method according to claim 28, wherein the partially crosslinked polymer terminates in amine and/or isocyanate groups.

34. A method according to claim 18, wherein the polymer precursor comprises a further, preferably linear, polymer species.

35. A method according to claim 34, wherein the further polymer species terminates in amine and/or isocyanate groups.

36. A method according to claim 34, wherein the further polymer species comprises a polyether polymer.

37-39. (canceled)

40. A polymer network according to claim 1, wherein the first network polymer comprises a crosslinking portion comprising a borate group
